(19) United States
(12) Patent Application Publication
(10) Pub. No.: US 2003/0110830 A1
(43) Pub. Date: Jun. 19, 2003

(54) Methods and apparatuses for measuring the compliance of stents and stented grafts

(76) Inventors: Mark Dehdashtian, Costa Mesa, CA (US); William E. Krams, Downey, CA (US); Sanjay Shrivastava, Newport Beach, CA (US); Nareth Dy, Tustin, CA (US); Adnan Nabulsi, South Gate, CA (US)

Correspondence Address: Edwards Lifesciences LLC, Law Dept., One Edwards Way, Irvine, CA, 92614, US

(21) Appl. No.: 09/911,353

(22) Filed: Jul. 23, 2001

(51) Int. Cl. G01M 3/02

(52) U.S. Cl. 73/37

(57) ABSTRACT

Methods and apparatuses for testing the compliance of stents and stented grafts, including pre-testing them in a pre-tester tube prior to accelerated fatigue testing. The pre-tester tube is a simulated human vessel that may be made of animal tissue having approximately the same size as the human target vessel. The pre-test involves pressurizing the pre-tester tube at various normal and abnormal physiologic pulsed pressures with the stent or stented graft in place. By measuring the expansion of the pre-tester tube, the proper expansion rate of the stent or stented graft is determined. Those data are then used in a feedback loop to control the amount of expansion of a synthetic tester tube in the accelerated fatigue tests. The tester regulates the pressure in the tester tube to attain the proper expansion magnitude during the test. The animal tissue may be porcine tissue, in particular a porcine aorta to simulate the human abdominal aorta. Any side branches of the porcine aorta are tied off.

### FIELD OF THE INVENTION

The present invention pertains generally to methods and systems for measuring implantable medical devices, and more particularly to methods of and systems for compliance testing endovascular stents and endovascular stented grafts.

### BACKGROUND OF THE INVENTION

The term “stent” is often used to describe tubular endoprosthetic devices which are implanted in blood vessels or other anatomical passageways of the body for the purpose of treating stenoses, aneurysms, occlusions, etc. Typically, such stents are implanted in blood vessels to maintain dilation and patency of an occluded region of blood vessel, or to bridge a weakened or aneurysmic region of blood vessel. On the other hand, some typical non-vascular applications of such stents are for the treatment of constrictions or injuries to the gastrointestinal tract (e.g., esophagus), ducts of the biliary tree (e.g., common bile duct) or anatomical passageways of the genitourinary tract (e.g., ureter, urethra fallopian tube, etc.). Any of these various anatomical target structures or lumens may be referred to herein as a “host lumen.” Depending on the design and intended use (coronary/peripheral), stents can range in diameter from 2 mm to more than 44 mm. Some stents are covered with or attached to solid (albeit sometimes porous) flexible tubular sleeves, typically a polyester or polytetrafluoroethylene (PTFE) fabric, in which case they are typically referred to as a “stented graft.” In the present application, the term “stent” may occasionally be used to collectively refer to either a stand-alone stent or a stented graft.

Most stents are initially disposed in a compact configuration of relatively small diameter, whereby the stent may be mounted upon or within a delivery catheter for insertion and transluminal advancement into the desired anatomical passageway. Thereafter, such stents are radially expandable to a larger “operative” diameter which is equal to or slightly larger than the diameter of the blood vessel or other anatomical passageway in which the stent is to be implanted. When radially expanded to such operative diameter, the stent will typically become released from the delivery catheter and embedded in or engaged with the surrounding wall of the blood vessel or other anatomical passageway.

Stents and the “stents” in stented grafts can be self-expanding or pressure-expandable. Self-expanding stents may be formed of resilient or shape memory material (e.g., spring steel or nitinol) which is capable of self-expanding from its first (radially compact) diameter to its second (operative) diameter without the exertion of any outwardly-directed force on the stent. Pressure-expandable stents may be formed of plastically deformable material (e.g., stainless steel) which is initially formed in its first (radially compact) diameter and remains stable until an outwardly directed pressure is exerted upon the stent to cause radial expansion and resultant plastic deformation thereof, to its second (operative) diameter. In either case, the stent or stented graft may be “oversized” with respect to the host lumen to facilitate anchoring therein. Oversizing can be defined as the interference or diametric difference between the OD of the stent and the ID of the lumen. Of course, the proper amount of oversizing is important, as too little may lead to migration of the stent, whereas too much may damage the host lumen.

An important consideration in the design and selection of a stent or stented grafts is its fatigue life or durability. Much insight into durability can be obtained with knowledge of the radial compliance of a stent, which in the case of a tube is generally defined as the nominal relationship between the radius of the tube and the expanded radius under maximum pressure inside that tube. Stent compliance is typically reported as a percent change of the diameter of the stent at a particular pressure range from its diameter at the mean pressure value. For example, durability of an endovascular Abdominal Aortic Aneurysm (AAA) graft, such as the bifurcated stented graft used in the Lifepath AAA® Graft System of Edwards Lifesciences, Irvine, Calif., largely depends on the compliance of the device while it is deployed in the human abdominal aorta. Though compliance values for the human abdominal aorta have been reported in the literature, there is some disagreement in the data. Generally, arteries are believed to expand between 2-7% in the systolic phase of the heartbeat cycle. Moreover, compliance of a stent deployed in the aorta is different from that of the aorta by itself. In order to filly understand the durability of the stent, it is imperative to understand the compliance of the stent when deployed in the aorta. Unfortunately, statistically significant in vivo studies are not available.

Compliance values for human abdominal aorta have been reported in literature previously¹ and are summarized in TABLE 1.

TABLE 1
Reported compliance values for human aorta under
various pressure ranges

| | | Pressure | | | |
|---|---|---|---|---|---|
| | | Difference | End | Diastolic- | |
| | | (Systolic- | Diastolic | Systolic | |
| | Pressure | Diastolic), | Diameter | Diameter | Compliance |
| Species | (mm Hg) | mm Hg | (mm) | (mm) | (%) |
| Human (19-35 years) | 116/64 | 52 | 15.5 | 1.5 | 10.3 |
| Human (male, av. 27 years) | 117/70 | 47 | 15.6 | 1.4 | 9.0 |
| Human (Female, av. 27 years) | 120/76 | 44 | 13.2 | 1.59 | 8.3 |
| Human (20-39 years) | 120/69 | 51 | 11.7 | 1.08 | 10.8 |

There are a variety of techniques and systems used to evaluate the radial compliance of stents in vitro. New stent and stented graft designs are typically post amendment class III devices which require the approval of a Food & Drug Administration (FDA) Pre-Market Approval application prior to commercial marketing. The FDA requires medical device manufacturers of stents to submit animal, clinical and in-vitro test data to support the safety and efficacy of the permanent implant device. One in-vitro test is accelerated durability testing which requires the equivalent of ten years of data, or 400 million cycles of fatigue, thus necessitating a rapid, highly reliable test system. Stent testing is typically performed by placing the stent(s) inside compliant tubes filled with saline or other fluids and subjected to internal pressure pulses using a pump assembly. In order to simulate physiological pressure and compliance conditions, compliant tubes of latex or silicone are selected to approximate the physiological behavior of the blood vessel (3-5% dilation for 100 mm Hg pressure change). The system is calibrated prior to the dynamic test by statically adjusting the pump assembly to produce cyclic pressures comparable to physiological pressures under the assumption that the stent, when combined with the tube, will then expand and relax as it would implanted, thereby subjecting the stent to realistic fatigue stress/strains. Two makers of such systems are EnduraTek of Minnetonka, Minn., and Dynatek® Dalta Scientific Instruments of Galena, Mo.

Despite these prior art systems, there remains a need in the art for a more accurate method and apparatus to measure the radial compliance of stents and stented grafts.

### SUMMARY OF THE INVENTION

The present invention provides a stent or stented graft compliance test assembly, comprising an animal tissue tube having opposed free ends and defining an inner lumen, a pre-tester including fixtures adapted to sealingly couple to the free ends of the animal tissue tube and a fluid supply in communication with at least one of the fixtures and the animal tissue tube lumen, and a stent or stented graft positioned within the animal tissue tube. The system may further include a pulsatile pumping system for the fluid supply that pressurizes the animal tissue tube lumen to pressures found in the human vascular system. A sensor such as a non-contact sensor of a laser micrometer measures the exterior diameter of the animal tissue tube.

The present invention also provides a method of testing the compliance of a stent or stented graft, comprising sealingly coupling opposed free ends of an animal tissue tube onto fixtures of a pre-tester, the animal tissue tube having a lumen, positioning a stent or stented graft within the animal tissue tube, and providing a fluid to the animal tissue tube lumen via at least one of the fixtures. The method may include pressurizing the fluid in the animal tissue tube lumen to pulsatile pressures found in the human vascular system, and measuring the exterior diameter of the animal tissue tube at different pressures.

In a preferred aspect, the step of positioning comprises positioning in the animal tissue tube a stented graft having multiple individual wires at axially spaced locations along an outer graft tube, and the method includes:

pressurizing the fluid in the animal tissue tube lumen to pulsatile pressures found in the human vascular system; and

measuring the exterior diameter of the animal tissue tube at the axially spaced locations and at different pressures.

The preferred method desirably further includes:

recording the data on the measured exterior diameter of the animal tissue tube;

sealingly coupling opposed free ends of a synthetic tube onto fixtures of a tester, the synthetic tube having a lumen;

positioning within the synthetic tube a stented graft of the same kind as was pre-tested in the animal tissue tube;

providing a fluid to the synthetic tube lumen via at least one of the fixtures of the tester;

pressurizing the fluid in the synthetic tube lumen at a pulsed rate; and

measuring the exterior diameter of the synthetic tube at the axially spaced locations while controlling the fluid pressure based on the recorded data such that the diameters of the synthetic tube at the axially spaced locations expands to the same dimensions as the measured diameter of the exterior diameter of the animal tissue tube at the axially spaced locations.

Another aspect of the invention is a method of testing the compliance of a stent or stented graft, including first sealingly coupling opposed free ends of a pre-tester tube onto fixtures of a pre-tester, the pre-tester tube having a lumen. A stent or stented graft is positioned within the pre-tester tube. A fluid is provided to the pre-tester tube lumen via at least one of the fixtures, and pressurized to pulsatile pressures found in the human vascular system. The exterior diameter of the pre-tester tube is measured at different pressures, and the data recorded. Next, opposed free ends of a tester tube having a lumen are sealingly coupling onto fixtures of a tester. A stent or stented graft of the same kind as was pre-tested in the pre-tester tube is positioned within the tester tube, and a fluid is provided to the tester tube lumen via at least one of the fixtures of the tester. The fluid in the tester tube lumen is pressurized at a pulsed rate, and the exterior diameter of the tester tube measured while controlling the fluid pressure based on the recorded data. The pre-tester tube is desirably made of animal tissue.

Further objects and advantages of the present invention will become apparent to those skilled in the art upon reading and understanding of the following detailed description and accompanying drawings.

### BRIEF DESCRIPTION OF THE DRAWINGS

These, as well as other features of the present invention, will become more apparent upon reference to the drawings wherein:

FIG. 1 is a perspective view of an exemplary stent or stented graft tester of the present invention showing a stented graft positioned within a tester tube;

FIG. 2 is an elevational view of the stent or stented graft tester of FIG. 1; and

FIG. 3 is an elevational view of a pre-test tube of animal origin coupled between two fixtures of a pre-tester and having a stented graft positioned therewithin;

FIG. 4 is a graph of wall thickness for various porcine aortas used in an exemplary pre-test assembly of the present invention;

FIG. 5 is a graph of porcine aorta internal diameters (ID) at 100 mm of mercury for various aortas as measured using the exemplary pre-test assembly;

FIG. 6 is a graph of porcine aorta compliances measured at 120/80 mm of mercury as determined using the exemplary pre-test assembly;

FIG. 7 is a graph showing the effect of pressure range on the average compliance of bare aorta as measured using the exemplary pre-test assembly;

FIG. 8 is a graph of the compliance of graft-deployed aortas measured using wires of various diameters as determined using the exemplary pre-test assembly;

FIG. 9 is a graph of the compliances of graft-deployed aortas for oversizing greater than 2 mm only as determined using the exemplary pre-test assembly;

FIG. 10 is a graph showing the effect of oversizing on compliance shown for a graft having a 0.012 inches diameter wire as measured using the exemplary pre-test assembly;

FIG. 11 is a graph comparing the bare aorta and the graft-deployed aorta compliances for various tests used in the exemplary pre-test assembly; and

FIG. 12 is a graph of the compliances of graft-deployed aortas plotted as a function of the compliance of bare aorta at 120/80 mm of mercury as measured using the exemplary pre-test assembly.

### DESCRIPTION OF THE PREFERRED EMBODIMENTS

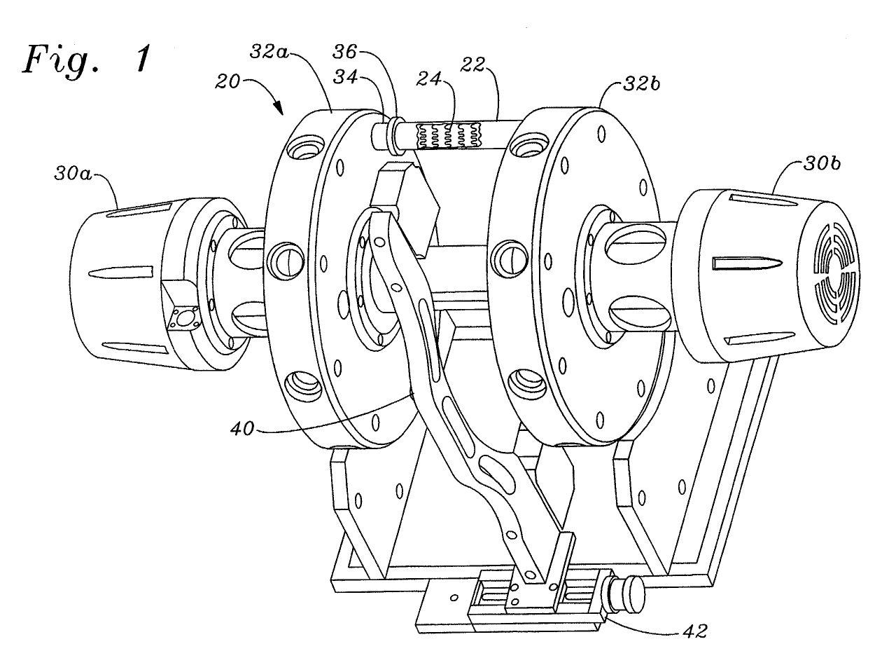

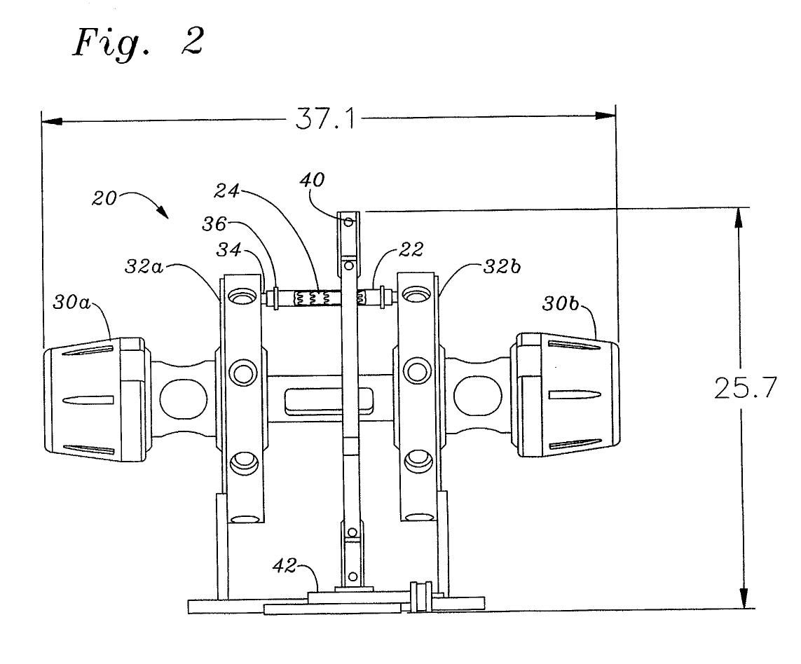

Referring now to the drawings, which are for purposes of illustrating a preferred embodiment of the present invention only, and not for purposes of limiting the same, FIGS. 1 and 2 illustrate a stent or stented graft compliance tester 20 of the present invention designed to supply pulsed pressure to the inner lumen of a tube 22, or a plurality of tubes simultaneously. In the illustrated embodiment, only one such tube 22 is shown for clarity, though apertures for mounting eight tubes are shown. A stented graft 24 is seen positioned within the tube 22, which may be transparent. The tube 22 is typically synthetic and selected to have compliance similar to the human anatomy For example, tubes of latex or silicone are normally used, with silicone providing visibility.

Several such testers 20 are available on the market, and the presently illustrated tester is a Stent Graft Tester (SGT) made by EnduraTEC Systems Corporation of Minnetonka, Minn. The details of the SGT 20 are not the subject of the present application, except as they provide the environment in which to test the stents or stented grafts in accordance with the principles of the invention. Nevertheless, a short description of the SGT 20 is appropriate.

The SGT 20 uses two pistons (contained within end housings 30a, 30b), which compress a 37±3° C. phosphate buffered 0.9 percent aqueous saline solution contained in the channels of two cylindrical Delrin manifolds 32a, 32b. Each pair of channels fluidly communicates through a horizontally oriented tube, such as tube 22, in which a stented graft 24 is deployed. To facilitate this fluid pathway, the tube 22 is sealingly coupled at each free end to the manifold channels via a pair of fixtures 34. By way of example, the fixtures 34 may each comprise a small rigid tube threaded into the respective manifold 32a, 32b and sized to fit within the lumen of the tube 22. The free ends of the tube 22 are held onto the fixture 34 with an O-ring or hose clamp 36 placed around the tube. Access ball valves (not shown) located on each side of the manifolds 32a, 32b are used to deploy the stented graft 24 into the tubes 22 on the SGT 20.

The pistons displace saline solution, which generates radial oscillations in the tube 22. The oscillation frequency and the amplitude of the pistons are controlled using computer software, for example EnduraTEC control software labeled Quicktest (version 1.1998.06.15).

FIGS. 1 and 2 also illustrate a stand 40 used to support a sensor (not shown) for measuring the tube external diameters. For example, a laser micrometer such as a Keynce Lasermic model LS-5041T may be used for measuring the OD amplitude on the pulsating tube 22 directly. The sensor is also capable of measuring the maximum, minimum and the mean diameter of the pulsating tube 22. An ultrasound sensor may also be used, and may be adapted to measure the dimensions of the inside of the tube 22 (i.e., the ID of the tube). It will be noted that the stand 40 is mounted on a slide mechanism 42 for linear movement in a direction parallel to the axis of the tube 22. Movement of the sensor in this manner enables measurement of the exterior diameter of the tube 22 at different locations along its axis. In the illustrated tester 20, the manifolds 32a, 32b are cylindrical and mounted for rotation on a stand such that different tubes 22 may be positioned in operational proximity to the measurement sensor.

Although not shown, a pressure transducer is used to monitor the pressure pulse in the tube 22. The transducer is located inside the tube 22 and connected to a data acquisition system. Pressure pulses are monitored through the entire duration of the compliance measurements. The tester 20 of FIGS. 1 and 2 is used for batch accelerated compliance testing of stents or stented grafts placed within the plurality of tubes 22. The testing involves pressurizing the fluid in the lumen of the tubes 22 at a pulsed rate, and controlling the expansion of the stents or stented grafts within the tubes to that which would be experienced in vivo. In the past, the control was based on maintaining the appropriate physiological pressures in the tubes 22. In the present invention, expansion of the stents or stented grafts is controlled by measuring the exterior diameter of the tubes 22 and controlling the fluid pressure based on data derived from a pre-test of the same stent or stented graft. The pre-test comprises sealingly coupling opposed free ends of a pre-tester tube onto fixtures of a pre-tester, positioning a stent or stented graft within the pre-tester tube, pressurizing a fluid in the pre-tester tube lumen to pulsatile pressures found in the human vascular system, measuring the exterior diameter of the pre-tester tube at different pressures, and recording the data on the measured exterior diameter of the pre-tester tube. The data derived from the pre-test is then used to control the expansion of the tubes 22. That is, the diameter of the tubes 22 is monitored during the test and, using a feedback control loop, the pulsed fluid pressures within the tubes are adjusted to maintain the tube expansion the same as that recorded in the pre-test. In this way, expansion of the stents or stented grafts during the test is maintained at the magnitude of that in the pre-test, which simulates the conditions in vivo.

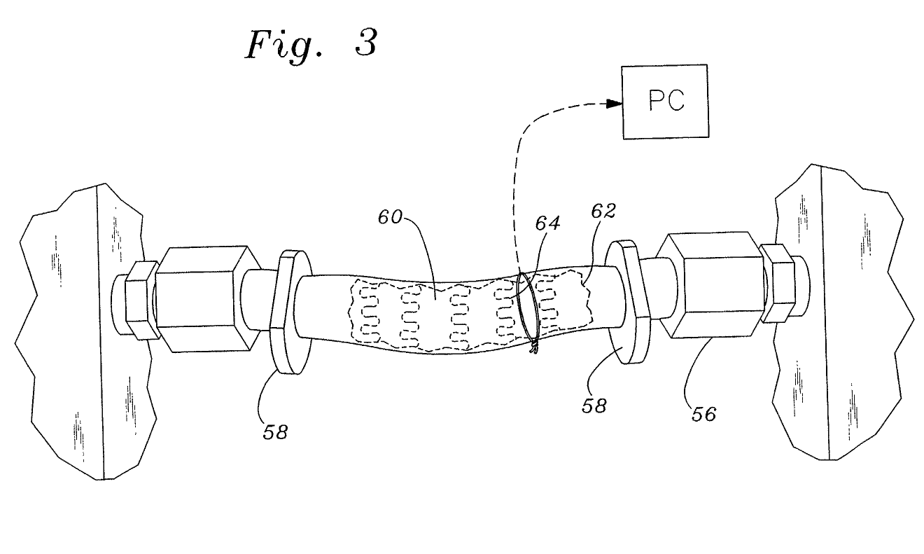

FIG. 3 illustrates a pre-tester 50 in which is mounted a pre-tester tube 52. Although the pre-tester 50 may be the same configuration as the tester 20 of FIGS. 1 and 2, it may be a different apparatus at a different location, or may be a different configuration altogether. The pre-tester 50 includes a pair of spaced-apart manifolds 54a, 54b to which a pair of axially aligned fixtures 56a, 56b mount. The opposed free ends of the pre-tester tube 52 are sealingly coupled to the fixtures 56a, 56b via O-rings or hose clamps 58 placed around the tube 52.

In the same way as was described previously with respect to the tester 20, the pre-tester 50 of FIG. 3 includes a mechanism that compresses a 37±3° C. phosphate buffered 0.9 percent aqueous saline solution contained in internal channels of the manifolds 54a, 54b. Each pair of channels fluidly communicates through the horizontally-oriented tube 52 in which a stent or stented graft is deployed. FIG. 3 illustrates in phantom a stented graft 60 positioned within the pre-tester tube 52. The stented graft 60 includes a flexible tubular graft portion 62 and a plurality of axially spaced wires 64, typically each formed in a sinusoidal pattern. The aggregation of wires 64 comprises the “stent” of the stented graft 60. One example of such a stented graft construction is of the type used in the Lifepath Abdominal Aortic Aneurysm (AAA) Graft System of Edwards Lifesciences, Irvine, Calif. The Lifepath AAA device is a bifurcated graft, and it should be understood that adapter mandrels for the tester 20 and pre-tester 50 may be provided to test the compliance of such grafts.

The pre-test utilizing the pre-tester 50 is designed to determine the compliance values of the particular stent or stented graft as closely as possible to actual physiological conditions. To that end, the pre-tester tube 52 comprises a material that closely mimics the compliance characteristics of the particular anatomical lumen(s) into which the stent or stented graft will likely be deployed. Various materials, both natural and synthetic, may be used, though tubes of animal tissue are preferred. Human arterial vessels could be used, though the supply of such material is problematic and dependent on voluntary donors. As such, animal vessels having approximately the same shape and size as the vessel of interest are most useful. Some animal sources that are contemplated are pigs (porcine tissue), horses (equine tissue), dogs (canine tissue), and the like. In one specific application for abdominal aortic aneurysms, porcine aortas have approximately the same diameter and can be trimmed to a sufficient length for the pre-test. The aortas are sealed by tying a thread around each side branch and tested for any leaks prior to storage and use.

The pre-test includes first testing the bare (without the stent or stented graft) pre-tester tube 22 at normal and abnormal physiological pressures, and measuring the compliance thereof. Thereafter, the stent or stented graft of interest is placed within the pre-tester tube 22 and fixed therein by simply releasing the stent to expand on its own, or by internally expanding and plastically deforming the stent using a balloon catheter, for example. A number of measurements are then taken of the compliance of the pre-tester tube 22 at different physiological pressures. The compliance values are recorded and subsequently used in the accelerated batch testing using the tester 20.

It should be noted that in the following discussion, compliance is defined as the percent change in diameter of the vessel, with or without the device, taking place due to the pulsation at the given systolic and diastolic pressures. Compliance values are obtained by dividing the outer diameter (OD) amplitude of the pre-tester tube under the given pulsation by the mean internal diameter (ID) of the pre-tester tube and multiplying by 100. The above definition has been chosen because expressing compliance as a percent of the internal diameter of the vessel seems to be most logical. At the same time, measurements of the amplitude are conducted on the outer diameter.

1 Pre-Testing of Porcine Aortas

Results of testing a porcine aorta with and without a stented graft are provided below, as well as more specifics with regard to the test regimen. In summary, compliances of porcine aorta were found to be in the range of 4.9-9 percent with an average of 6.52 percent at 120/80 mm of mercury. Compliances of the graft-deployed aorta were also measured at four pressure ranges, i.e., 140/60, 130/70, 120/80, and 115/85 mm of mercury. It was observed that the compliance of the graft-deployed aorta was significantly less than that of the bare aorta. In addition, the compliance of the graft-deployed aorta was found to be dependent on the wire diameter used in the device. Devices made of four different wire diameters, i.e., 0.012 inches, 0.014 inches, 0.015 inches and 0.016 inches were used in the study. It was observed that the compliance of the device-deployed aorta significantly decreased as the wire diameter increased. For the case of devices made of a wire of 0.015 inches diameter, additional measurements were taken at 140/60 mm of mercury.

The compliance of the graft-deployed aorta with different wire diameters is given below in TABLE 2:

TABLE 2

| | Average | Average |
|---|---|---|
| | Compliance of | Compliance of |
| | Graft Deployed | Graft Deployed |
| Wire Diameter | Aorta at 120/80 | Aorta at 130/70 |
| (inches) | mm Hg (%) | mm Hg (%) |
| 0.012 | 1.35 | 1.80 |
| 0.014 | 0.84 | 1.26 |
| 0.015 | 0.55 | 0.84 |
| 0.016 | 0.57 | 0.85 |

Compliances were also found to be dependent on the extent of oversizing used in deploying the device. As the oversizing increased, the compliance of the device-deployed aorta decreased for a 0.012 inches wire. In the case of thicker wires, the effect of oversizing on the compliance was less prominent.

The results of this study strongly suggest that the devices made of wire diameters of 0.014 inches, 0.015 inches, and 0.016 inches have significantly smaller compliance as compared to those made with 0.012 inches wire. In addition, data also suggest that the compliances of grafts prepared using larger wire diameter are less dependent on the extent of oversizing. Both of the above observations make the larger wire diameter more desirable from the device durability point of view.

2. Experimental Procedure

2.1 Test Materials

Seven batches of large porcine aortas were used in this study. Porcine aortas were obtained from a slaughterhouse. Lifepath AAA® straight grafts of 19×90, 21×90, 23×60 and 25×46 mm sizes prepared using the wires of diameters 0.012 inches, 0.014 inches, 0.015 inches and 0.016 inches were used in this study. While initial studies were done on many sizes, the 25×46 mm graft was chosen for establishing the effect of wire diameter on compliance. Most of the data were obtained on this size.

2.2 Equipment

EnduraTEC Systems Corporation Stent Graft Tester (SGT) as seen in FIGS. 1 and 2.

2.3 Porcine Aorta Preparation

Aortas were shipped by overnight mail from the slaughterhouse. They were constantly stored in saline solution during the shipment. Upon the receipt of aortas, they were sorted based on diameters. The aortas with desirable diameters were immediately cleaned and cut into the desired length of 12.5 cm. The cleaning procedure includes pinning the thoracic portion on a board to prevent any movement while cleaning. Descending aortic segment was cut from the aortas and any loose or torn tissue hanging from the artery was removed using dissection scissors and surgical tweezers. Caution was taken to avoid cutting the side branches too short as a minimum length is needed to use a vascular clip or suture to seal side branches. During cleaning, side branches of aortas were closed by tying a thread around each side branch. The aortas were tested for any leaks prior to storage. The prepared aortas were stored in saline solution in a refrigerator and used for testing within 72 hours from receipt.

2.4 Measurement Procedure

Wall thickness of each of the selected aortas was measured at five locations on each end. An average of these measurements was used as the wall thickness of the aorta. Aortas were deployed onto the tester and several measurements were carried out on the bare aorta. Note that the term bare aorta will henceforth be used to describe aorta without the deployment of the graft. OD of each aorta was measured at five locations along the length at four different pressure levels, i.e., no external pressure, and 80, 100 and 120 mm of Hg externally applied pressure. ID of each aorta was derived by subtracting twice the wall thickness from the respective OD values. Normally there was a slight taper in the aorta along the portion of the length that was used for these measurements. For the purpose of calculations, the mean of the five measurements taken along the length was used. These measurements were taken over the length segment where the graft was located. Normal test duration for the compliance measurements on each aorta including those with the graft deployed was two hours. Aortas were continuously in contact with saline from the inside during this period. Periodic sprays of saline solution were used at an interval of five minutes to keep them hydrated externally as well.

A tube on the SGT was replaced with porcine aorta for the purpose of the compliance testing (see FIG. 3). Compliance of the bare aortas was measured at three pressure ranges, i.e., 115/85, 120/80 and 130/70 mm Hg. A pulsatile frequency of 1.2 Hz (equivalent to 72 beats per minute) was used in all compliance measurements reported here. At each pressure range, measurements at five locations along the length of the aorta were used. Compliance measurements were conducted using a Keynce Lasermic instrument, which measures the OD amplitude directly at each location. OD amplitude is the difference between the maximum and the minimum OD of a tube/aorta while being subjected to a pulsatile motion. Compliance values were calculated by dividing the OD amplitude by the mean ID of the aorta measured at 100 mm of mercury at each location, respectively. Mean of all of the compliances calculated on each aorta was used as the compliance of each aorta at the given pressure range.

After the measurements on the bare aorta were complete, the graft of the desired size was deployed in the aorta while it was maintained at 100 mm of mercury on the tester. Upon the deployment of the graft, the static measurements of OD at no external pressure, and 80, 100, and 120 mm of Hg externally applied pressure were obtained. Likewise, the dynamic measurements of compliance at 115/85, 120/80 and 130/70 mm of Hg were obtained. Measurements were carried out at each of the wireform locations as well as between the wireforms. Compliance values of graft-deployed aortas were calculated based on the OD difference measured at wireform locations.

Twenty-five aortas obtained in seven batches were used for these compliance measurements. Measurements were conducted on grafts prepared with wireforms having four different wire diameters, i.e., 0.012 inches, 0.014 inches, 0.015 inches and 0.016 inches. Three to six grafts for each wire diameter were used in compliance determination.

For the case of devices made of wire having a diameter of 0.015 inches, measurements were also taken at 140/60 mm of mercury. In tests conducted using one of the batches of aortas (batch number 10), all of the above measurements were conducted at 140/60 mm of mercury also.

3. Experimental Data and Analysis

The detailed data are shown in the Appendix. It should be noted here that each batch of porcine aortas received was assigned a batch number. Batch numbers 1 through 10 were received. The data reported pertain only to batch numbers 3-6 and 8-10 because batches 1 and 2 were used for developing procedures to clean aortas and tie them to make them leak-free, hence no compliance measurements were carried out on these batches, and batch 7 aortas were smaller than anticipated hence were not used for straight graft measurements. Out of the remaining batches, three to six aortas per batch were in the desired length and diameter and were made leak proof. These were the aortas used for testing. It should be noted that data taken in test 3.1 would not be considered here because aortas were initially drying up in the air during the test. Test number 3.2 onwards, a technique periodically sprayed aortas with an aqueous saline solution during testing. It should also be noted here that test batch number 5.2 used a stainless steel wire of 0.015 inches diameter. The stainless steel data will not be discussed in this report as they are out of context here.

3.1 Porcine Aorta Sizes

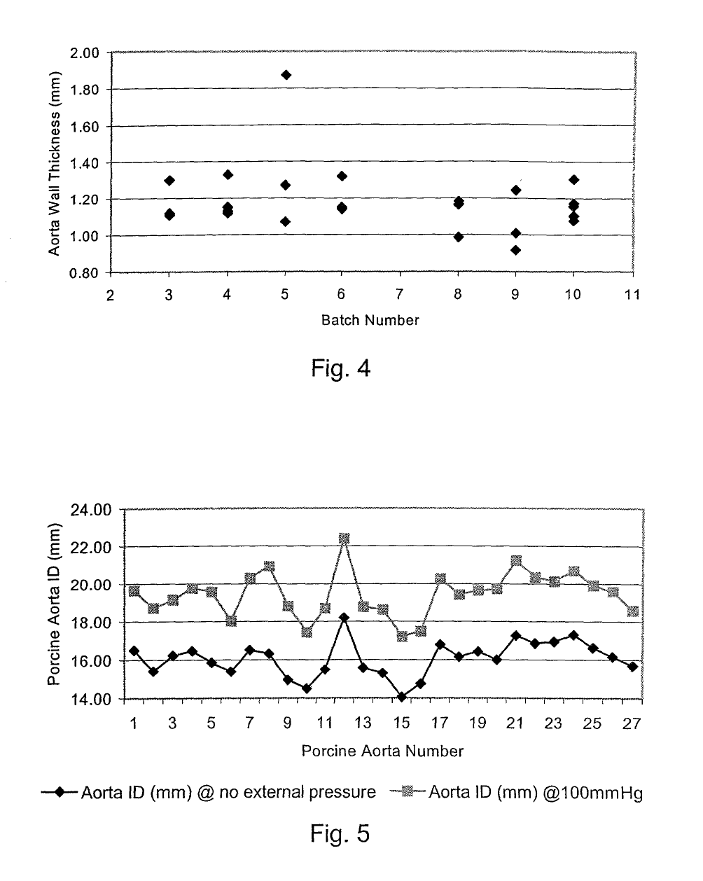

The diameters and wall thickness of porcine aortas used in this study are given in TABLE 3 and plotted in FIGS. 4 and 5, respectively. The ID of aortas used in this study ranged from 17.2 to 22.4 mm when measured at 100 mm of mercury. Overall average ID of all of the test aortas was 19.4 mm. The IDs of the same aortas when measured without applying any external pressure ranged from 14.1 to 18.2 mm with an average of 16.1 mm.

Wall thickness of aortas used varied between 0.92 and 1.87 mm with an average of 1.21 mm. Wall thickness to ID ratio of all test aortas varied between 0.05-0.11. This is in agreement with the corresponding number reported in the literature for human aortas between 0.05-0.10.³

TABLE 3
Dimensions and compliances of bare
porcine aortas used in the test. Compliances
given in this table represent the values prior
to the deployment of a stented graft (Lifepath AAA ®
device).

| | | Aorta | Aorta ID | | Compliance | |
|---|---|---|---|---|---|---|
| | | wall | (mm) @ | Aorta | @ 120/80 | Wall |
| | | thick- | no | ID (mm) | mm Hg | thick- |
| Aorta | | ness | external | @ | (without | ness/ |
| batch # | Test # | (mm) | pressure | l00 mm Hg | graft) | ID |
| 3 | 3.2 | 1.30 | 16.51 | 19.65 | 6.80 | 0.07 |
| 3 | 3.3 | 1.12 | 15.40 | 18.73 | 5.40 | 0.06 |
| 3 | 3.4 | 1.11 | 16.23 | 19.15 | 5.50 | 0.06 |
| 4 | 4.1 | 1.15 | 16.46 | 19.75 | 7.40 | 0.06 |
| 4 | 4.2 | 1.13 | 15.86 | 19.57 | 7.00 | 0.06 |
| 4 | 4.3 | 1.33 | 15.38 | 18.04 | 7.00 | 0.07 |
| 4 | 4.4 | 1.12 | 16.52 | 20.29 | 9.00 | 0.06 |
| 5 | 5.1 | 1.27 | 16.32 | 20.93 | 7.20 | 0.06 |
| 5 | 5.2 | 1.87 | 14.94 | 18.83 | 9.00 | 0.10 |
| 5 | 5.3 | 1.87 | 14.49 | 17.43 | 6.20 | 0.11 |
| 5 | 5.4 | 1.07 | 15.50 | 18.70 | 5.60 | 0.06 |
| 6 | 6.1 | 1.15 | 18.20 | 22.40 | 7.20 | 0.05 |
| 6 | 6.2 | 1.32 | 15.59 | 18.78 | 6.40 | 0.07 |
| 6 | 6.3 | 1.14 | 15.31 | 18.64 | 5.90 | 0.06 |
| 8 | 8.1 | 0.99 | 14.05 | 17.22 | 7.77 | 0.06 |
| 8 | 8.2 | 1.16 | 14.75 | 17.49 | 5.83 | 0.07 |
| 8 | 8.3 | 1.17 | 16.80 | 20.26 | 5.44 | 0.06 |
| 8 | 8.4 | 1.18 | 16.16 | 19.42 | 6.70 | 0.06 |
| 9 | 9.1 | 0.92 | 16.44 | 19.64 | 5.59 | 0.05 |
| 9 | 9.2 | 1.01 | 16.02 | 19.72 | 7.90 | 0.05 |
| 9 | 9.3 | 1.24 | 17.27 | 21.25 | 7.08 | 0.06 |
| 10 | 10.1 | 1.31 | 16.87 | 20.34 | 5.07 | 0.06 |
| 10 | 10.2 | 1.16 | 16.95 | 20.13 | 5.55 | 0.06 |
| 10 | 10.3 | 1.17 | 17.30 | 20.68 | 5.56 | 0.06 |
| 10 | 10.4 | 1.10 | 16.63 | 19.92 | 5.79 | 0.06 |
| 10 | 10.5 | 1.16 | 16.16 | 19.58 | 7.30 | 0.06 |
| 10 | 10.6 | 1.08 | 15.69 | 18.58 | 4.90 | 0.06 |

| | | | | | |
|---|---|---|---|---|---|
| Average | 1.21 | 16.07 | 19.45 | 6.52 | 0.06 |
| Std. Dev. | 0.21 | 0.93 | 1.19 | 1.11 | 0.01 |
| Max | 1.87 | 18.20 | 22.40 | 9.00 | 0.11 |
| Mm | 0.92 | 14.05 | 17.22 | 4.90 | 0.05 |

3.2 Compliance of Bare Porcine Aorta

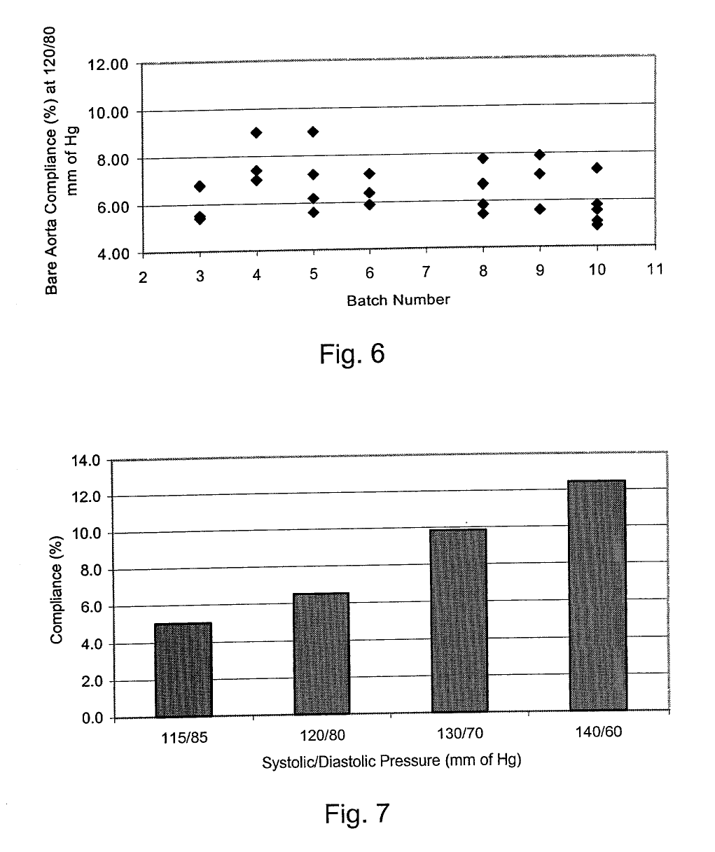

Compliance of bare porcine aorta measured at 120/80 nm of mercury are shown in FIG. 6 for all of the porcine aortas used in this study. Data are also shown in TABLE 3. Average compliance of porcine aorta is 6.5 percent with a standard deviation of 1.1 percent. All of the compliance values measured was between 4.9 percent and 9 percent.

3.3 Effect of Pressure on Compliance

compliances varied depending on the pressure range used for measurements. FIG. 7 shows the average compliances of bare aorta measured at four pressure ranges. Data clearly show that the compliance increases as the pressure range increases.

3.4 Compliance of Graft-Deployed Aorta

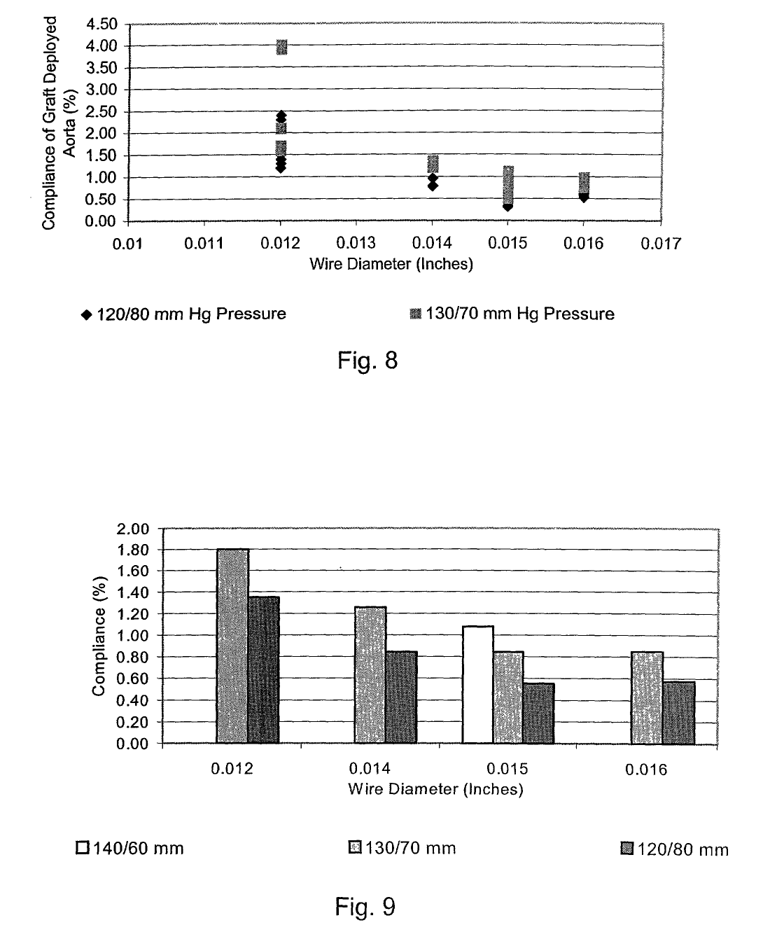

Compliance of graft-deployed aortas are shown in TABLES 4 and 5 and plotted in FIGS. 8 and 9, respectively. These figures show that compliance of the graft-deployed aorta is significantly less than that of the bare aorta under all conditions tested. Furthermore, it was observed that the compliance of the graft-deployed aorta depends on the diameter of the wire used in the graft. Compliances decrease significantly as the wire diameter increases. These data are based on various grafts tested in aortas of varying diameters. It is important to note a term called “oversizing” at this point as this will be used repeatedly here on in this report. Oversizing is the difference between the graft OD and the aorta ID. Aorta ID is measured at a pressure of 100 mm of mercury.

TABLE 4
Compliances of graft-deployed aortas having
wires of various diameters.
Graft Deployed Compliances

| | | | | Compliance of | Compliance of | Compliance of |
|---|---|---|---|---|---|---|
| | Wire | Graft | | graft deployed | graft deployed | graft deployed |
| Test | diameter | size | Oversizing | aorta at 120/80 | aorta at 130/70 | aorta at 140/60 |
| number | (inches) | (mm) | (mm) | mm Hg | mm Hg | mm Hg |
| 3.3 | 0.012 | 19 | 0.6 | 2.30 | 3.90 | |
| 4.4 | 0.012 | 21 | 1.0 | 2.40 | 4.00 | |
| 3.2 | 0.012 | 23 | 3.7 | 1.50 | | |
| 4.2 | 0.012 | 23 | 3.7 | 1.40 | 2.10 | |
| 4.1 | 0.012 | 25 | 5.6 | 1.20 | 1.60 | |
| 4.3 | 0.012 | 25 | 7.3 | 1.30 | 1.70 | |
| 5.1 | 0.014 | 21 | 4.4 | 0.78 | 1.35 | |
| 5.4 | 0.014 | 23 | 4.5 | 0.79 | 1.21 | |
| 5.3 | 0.014 | 25 | 7.9 | 0.96 | 1.21 | |
| 10.5 | 0.015 | 23 | 3.8 | 0.43 | 0.74 | 1.15 |
| 9.3 | 0.015 | 25 | 4.2 | 0.47 | 0.66 | 0.99 |
| 10.3 | 0.015 | 25 | 4.7 | 0.49 | 0.84 | 1.27 |
| 10.6 | 0.015 | 23 | 4.8 | 0.35 | 0.65 | 0.84 |
| 10.1 | 0.015 | 25 | 5.0 | 0.52 | 0.80 | 0.99 |
| 8.3 | 0.015 | 25 | 5.1 | 0.86 | 0.95 | |
| 10.2 | 0.015 | 25 | 5.3 | 0.64 | 0.93 | 1.28 |
| 10.4 | 0.015 | 25 | 5.5 | 0.59 | 0.99 | 1.34 |
| 9.2 | 0.015 | 25 | 5.7 | 0.47 | 0.82 | 1.28 |
| 9.1 | 0.015 | 25 | 5.8 | 0.31 | 0.51 | 0.54 |
| 8.4 | 0.015 | 25 | 6.0 | 0.61 | 0.96 | |
| 8.2 | 0.015 | 25 | 7.9 | 0.74 | 1.12 | |
| 8.1 | 0.015 | 25 | 8.2 | 0.70 | 1.01 | |
| 6.1 | 0.016 | 25 | 2.9 | 0.58 | 0.98 | |
| 6.3 | 0.016 | 23 | 4.8 | 0.53 | 0.76 | |
| 6.2 | 0.016 | 25 | 7.0 | 0.61 | 0.80 | |

TABLE 5
Summary of graft-deployed aorta compliances for various wire diameters

| | | | | | | | Percentage of | |
|---|---|---|---|---|---|---|---|---|
| | | | | | | | average | Calculated |
| | | | | | | | compliance at | compliance |
| | Compliance of graft deployed aorta for oversizing >2 mm (%) | | | | | | 120/80 mm Hg | ratios |
| | Range of | Range of | Range of | Average | Average | Average | pressure | relative to |
| Wire | compliance | compliance | compliance | compliance | compliance | compliance | relative to | 0.012 inches |
| Dia. | at 120/80 | at 130/70 | at 140/60 | at 120/80 | at 130/70 | at 140/60 | 0.012 inches | wire |
| (inches) | mm Hg | mm Hg | mm Hg | mm Hg | mm Hg | mm Hg | wire diameter | diameter |
| 0.012 | 1.2-2.4 | 1.6-4.0 | | 1.35 | 1.8 | | 100% | 100% |
| 0.014 | 0.78-0.96 | 1.21-1.35 | | 0.84 | 1.26 | | 62% | 54% |
| 0.015 | 0.31-0.86 | 0.51-1.12 | 0.54-1.34 | 0.55 | 0.84 | 1.08 | 41% | 41% |
| 0.016 | 0.53-0.61 | 0.76-0.98 | | 0.57 | 0.85 | | 42% | 32% |

3.5 Effect of Wire Diameter on Graft Compliance

As shown in TABLE 5 and FIG. 9, the average compliance with a graft having a 0.012 inches diameterwire was 1.35 percent at 120/80 mm of mercury pressure and 1.80 percent at 130/70 mm of mercury. The average compliance with a graft having a 0.014 inches diameter wire was 0.84 percent at 120/80 mm of mercury, and 1.26 percent at 130/70 mm of mercury. The corresponding numbers for a 0.015 inches wire were 0.55 percent at 120/80 mm of mercury, 0.84 percent at 130/70 mm of mercury, and 1.08 mm of mercury at 140/60 mm of mercury. For a 0.016 inches wire, the average compliance values were 0.57 percent and 0.85 percent for 120/80 and 130/70 mm of mercury pressure ranges, respectively.

The compliance measured in various tests varied between 1.2-2.4 percent at 120/80 mm of mercury pressure and between 1.6-4 percent at 130/70 mm of mercury with a graft having 0.012-inches diameter wire. Compliance with a graft having a 0.014 inches diameter wire varied between 0.78-0.96 percent at 120/80 mm of mercury and between 1.21-1.35 percent at 130/70 mm of mercury. The corresponding numbers for a 0.015 inches wire were 0.31-0.86 percent at 120/80 mm of mercury and 0.51-1.12 percent at 130/70 mm of mercury. For a 0.016 inches wire, the compliance values were in the range of 0.53-0.68 percent and 0.76-0.98 percent for 120/80 and 130/70 mm of mercury pressure ranges, respectively. The variability in these data is attributed largely to the variations in oversizing during each test.

By excluding the data below 2 mm of oversizing, a comparison is made among different wire diameters. As shown in TABLE 5, the average compliance using 0.014 inches, 0.015 inches and 0.016 inches wires are 62 percent, 41 percent and 42 percent, respectively, of that using a 0.012 inches wire at 120/80 mm of mercury. Relative compliances of the wire were calculated based on varying the wire diameter. Compliance is inversely proportional to the diameter to the 4^{th} power. Based on these calculations, the compliances of 0.014 inches, 0.015 inches, and 0.016 inches wires are 54 percent, 41 percent and 32 percent, respectively, of that of 0.012 inches wire. The experimental data on graft compliances are in good agreement with the calculations on wire compliances. One must keep in mind that the experimental data for each size were obtained for somewhat different oversizing because of limitations in the availability of aortas of predetermined sizes. Data taken at 130/70 mm of mercury pressure range follow a trend similar to what was observed at 120/80 mm of mercury.

3.6 Effect of Oversizing

It is clear from the preceding discussion that the extent of oversizing has an effect on the compliance of the graft deployed in an aorta. Data are shown for three categories of oversizing in TABLE 6 and also plotted in FIG. 10. The three categories used were less than 2 mm of oversizing, 3-4 mm of oversizing, and 5-8 mm of oversizing. A comparison is made for a 0.012 inches wire for these three categories. The data show that the average compliances are 2.35 percent, 1.45 percent and 1.25 percent, respectively for the above three categories at 120/80 mm of mercury. In other words, as the oversizing increases, the compliances decrease.

Data also suggest that the effect of oversizing on compliance is less for larger wire diameters. It implies that a graft made of a wire of larger diameter is less prone to the compliance change based on oversizing. Thus these data also imply another potential benefit of large wire diameter that the compliances of grafts prepared using these are less dependent on the extent of oversizing. It may be attributable to a larger difference between the stiffness of the graft prepared with a larger wire diameter and that of the bare aorta.

TABLE 6
Effect of oversizing on compliance.
Effect of Oversizing on Compliance

| Test | Wire Dia. | | | |
|---|---|---|---|---|
| Number | (inches) | Oversizing (mm) | 120/80 mm Hg | 130/70 mm Hg |
| 3.3/4.4 | 0.012 | <2 mm | 2.35 | 3.95 |
| 3.2/4.2 | 0.012 | 3-4 mm | 1.45 | 2.1 |
| 4.1/4.3 | 0.012 | 5-8 mm | 1.25 | 1.65 |

3.7 Comparison of the Bare Aorta and the Graft-Deployed Aorta

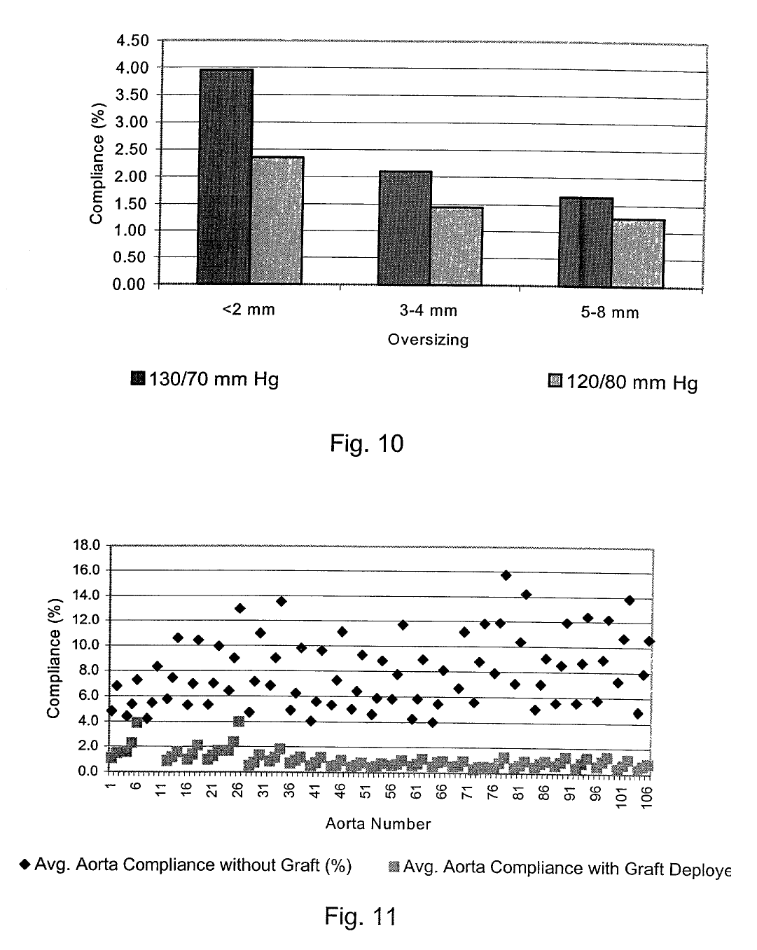

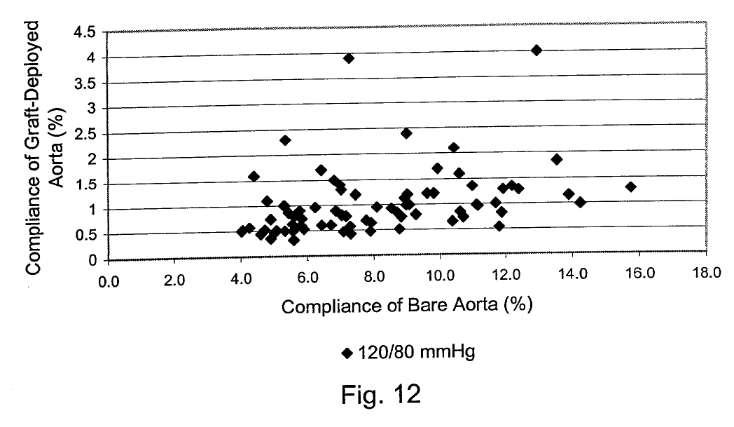

For all twenty-five tests, the compliances of bare aorta varied between 4.9 percent and 9 percent with an average of 6.5 percent at a pressure of 120/80 mm of mercury. Compliances of graft deployed aortas varied between 0.31 percent and 2.4 percent with an average of 0.86 percent at a pressure of 120/80 mm of mercury. The above numbers include all wire diameters tested. FIG. 11 shows a scatter graph of the compliance of bare aorta as well as the graft-deployed aorta for each test. Within each test, there appears to be a trend that one goes up with the other. However, that merely shows that both compliances, i.e., with or without the graft deployed increase as the test pressure range increases. A careful look at the data from various tests shows that there is no clear correlation between the two compliances as evident in FIG. 12.

4. Conclusions

The following conclusions can be drawn from this study:

1. Compliances of porcine aortas are close to those reported for human aortas.

2. Porcine aorta sizes were comparable to the reported human aorta sizes.

3. Compliances of aorta decrease significantly upon the deployment of the device.

4. Compliance of the device-deployed aorta is dependent on the wire diameter. Increasing wire diameter from 0.012 inches to 0.014 inches or 0.015 inches decreases compliances to 62 percent and 41 percent of that of 0.012 inches wire respectively. Average compliances measured at 130/70 mm of mercury for 0.012 inches, 0.014 inches, 0.015 inches and 0.016 inches wire were 1.80 percent, 1.26 percent, 0.84 percent, and 0.85 percent respectively.

5. Compliance of graft-deployed aorta with 0.014 inches and 0.015 inches wire were measured to be 0.84 percent and 0.55 percent, respectively at 120/80 mm of mercury.

6. Compliance of the graft-deployed aorta depends on the extent of oversizing. Greater oversizing reduces the compliance. The effect of oversizing on compliance appears to be more significant with the thinner wire (0.012 inches diameter). Thicker wires show less dependency on oversizing.

Additional modifications and improvements of the present invention may also be apparent to those skilled in the art. Thus, the particular combination of parts described and illustrated herein is intended to represent only one embodiment of the present invention, and is not intended to serve as limitations of alternative devices within the spirit and scope of the invention.

### Appendix

TABLE 7
Data on bare aortas.

| | | | | | | | Compliance without | |
|---|---|---|---|---|---|---|---|---|
| | | | | | | | Graft | |
| | | | | | | | Max and | |
| | | | | | | | Min | |
| | | | | | Aorta ID | | Pressure | |
| | | | | Aorta Average | (mm) @ | | for Bare | Avg. Aorta |
| | | Graft | Wire | wall | no | Aorta ID | Aorta | Compliance |
| | | Size | diameter | thickness | external | (mm) | Testing | without |
| Batch # | Test # | (mm) | (inches) | (mm) | pressure | @ 100 mm Hg | (mm Hg) | Graft (%) |
| 3 | 3.2 | 23 | 0.012 | 1.3 | 16.5 | 19.7 | 117/88 | 4.8 |
| 3 | 3.2 | 23 | 0.012 | 1.3 | 16.5 | 19.7 | 119/80 | 6.8 |
| 3 | 3.3 | 19 | 0.012 | 1.12 | 15.4 | 18.7 | 118/87 | 4.4 |
| 3 | 3.3 | 19 | 0.012 | 1.12 | 15.4 | 18.7 | 119/80 | 5.4 |
| 3 | 3.3 | 19 | 0.012 | 1.12 | 15.4 | 18.7 | 128/74 | 7.3 |
| 3 | 3.4 | N/A | N/A | 1.11 | 16.2 | 19.2 | 115/85 | 4.2 |
| 3 | 3.4 | N/A | N/A | 1.11 | 16.2 | 19.2 | 119.5/80 | 5.5 |
| 3 | 3.4 | N/A | N/A | 1.11 | 16.2 | 19.2 | 130/70 | 8.3 |
| 4 | 4.1 | 25 | 0.012 | 1.15 | 16.5 | 19.8 | 115/85 | 5.8 |
| 4 | 4.1 | 25 | 0.012 | 1.15 | 16.5 | 19.8 | 120/79.4 | 7.4 |
| 4 | 4.1 | 25 | 0.012 | 1.15 | 16.5 | 19.8 | 130/69 | 10.6 |
| 4 | 4.2 | 23 | 0.012 | 1.13 | 15.9 | 19.6 | 115/85 | 5.3 |
| 4 | 4.2 | 23 | 0.012 | 1.13 | 15.9 | 19.6 | 120/80 | 7.0 |
| 4 | 4.2 | 23 | 0.012 | 1.13 | 15.9 | 19.6 | 130/70 | 10.4 |
| 4 | 4.3 | 25 | 0.012 | 1.33 | 15.4 | 18.0 | 115/85 | 5.3 |
| 4 | 4.3 | 25 | 0.012 | 1.33 | 15.4 | 18.0 | 120/80 | 7.0 |
| 4 | 4.3 | 25 | 0.012 | 1.33 | 15.4 | 18.0 | 130/70 | 9.9 |
| 4 | 4.4 | 21 | 0.012 | 1.12 | 16.5 | 20.3 | 115/85 | 6.4 |
| 4 | 4.4 | 21 | 0.012 | 1.12 | 16.5 | 20.3 | 120/80 | 9.0 |
| 4 | 4.4 | 21 | 0.012 | 1.12 | 16.5 | 20.3 | 130/70 | 13.0 |
| 5 | 5.1 | 25 | 0.014 | 1.27 | 16.3 | 20.9 | 115/86 | 4.7 |
| 5 | 5.1 | 25 | 0.014 | 1.27 | 16.3 | 20.9 | 120/81 | 7.2 |
| 5 | 5.1 | 25 | 0.014 | 1.27 | 16.3 | 20.9 | 130/73 | 11.0 |
| 5 | 5.2 | 25 | 0.015 | 1.87 | 14.9 | 18.8 | 115/86 | 6.8 |
| 5 | 5.2 | 25 | 0.015 | 1.87 | 14.9 | 18.8 | 120/81 | 9.0 |
| 5 | 5.2 | 25 | 0.015 | 1.87 | 14.9 | 18.8 | 130/72 | 13.6 |
| 5 | 5.3 | 25 | 0.014 | 1.87 | 14.5 | 17.4 | 115/85 | 4.9 |
| 5 | 5.3 | 25 | 0.014 | 1.87 | 14.5 | 17.4 | 120/81 | 6.2 |
| 5 | 5.3 | 25 | 0.014 | 1.87 | 14.5 | 17.4 | 130/71 | 9.8 |
| 5 | 5.4 | 23 | 0.014 | 1.07 | 15.5 | 18.7 | 115/86 | 4.1 |
| 5 | 5.4 | 23 | 0.014 | 1.07 | 15.5 | 18.7 | 120/81 | 5.6 |
| 5 | 5.4 | 23 | 0.014 | 1.07 | 15.5 | 18.7 | 130/69.4 | 9.6 |
| 6 | 6.1 | 25 | 0.016 | 1.15 | 18.2 | 22.4 | 120/80 | 7.3 |
| 6 | 6.1 | 25 | 0.016 | 1.15 | 18.2 | 22.4 | 130/71 | 11.1 |
| 6 | 6.2 | 25 | 0.016 | 1.32 | 15.6 | 18.8 | 115/86 | 5.0 |
| 6 | 6.2 | 25 | 0.016 | 1.32 | 15.6 | 18.8 | 120/80 | 6.4 |
| 6 | 6.2 | 25 | 0.016 | 1.32 | 15.6 | 18.8 | 130/71 | 9.3 |
| 6 | 6.3 | 23 | 0.016 | 1.14 | 15.3 | 18.6 | 115/85 | 4.6 |
| 6 | 6.3 | 23 | 0.016 | 1.14 | 15.3 | 18.6 | 120/81 | 5.9 |
| 6 | 6.3 | 23 | 0.016 | 1.14 | 15.3 | 18.6 | 130/71 | 8.8 |
| 8 | 8.1 | 25 | 0.015 | 0.99 | 14.1 | 17.2 | 115/85 | 5.8 |
| 8 | 8.1 | 25 | 0.015 | 0.99 | 14.1 | 17.2 | 120/80 | 7.8 |
| 8 | 8.1 | 25 | 0.015 | 0.99 | 14.1 | 17.2 | 130/70 | 11.7 |
| 8 | 8.2 | 25 | 0.015 | 1.16 | 14.7 | 17.5 | 115/85 | 4.3 |
| 8 | 8.2 | 25 | 0.015 | 1.16 | 14.7 | 17.5 | 120/81 | 5.8 |
| 8 | 8.2 | 25 | 0.015 | 1.16 | 14.7 | 17.5 | 130/73 | 8.9 |
| 8 | 8.3 | 25 | 0.015 | 1.17 | 16.8 | 20.3 | 115/85 | 4.0 |
| 8 | 8.3 | 25 | 0.015 | 1.17 | 16.8 | 20.3 | 120/81 | 5.4 |
| 8 | 8.3 | 25 | 0.015 | 1.17 | 16.8 | 20.3 | 130/72 | 8.1 |
| 8 | 8.4 | 25 | 0.015 | 1.18 | 16.2 | 19.4 | 115/85 | |
| 8 | 8.4 | 25 | 0.015 | 1.18 | 16.2 | 19.4 | 120/82 | 6.7 |
| 8 | 8.4 | 25 | 0.015 | 1.18 | 16.2 | 19.4 | 130/70 | 11.2 |
| 9 | 9.1 | 25 | 0.015 | 0.92 | 16.4 | 19.6 | 120/81 | 5.6 |
| 9 | 9.1 | 25 | 0.015 | 0.92 | 16.4 | 19.6 | 130/72 | 8.8 |
| 9 | 9.1 | 25 | 0.015 | 0.92 | 16.4 | 19.6 | 140/63 | 11.8 |
| 9 | 9.2 | 25 | 0.015 | 1.01 | 16.0 | 19.7 | 120/81 | 7.9 |
| 9 | 9.2 | 25 | 0.015 | 1.01 | 16.0 | 19.7 | 130/71 | 11.9 |
| 9 | 9.2 | 25 | 0.015 | 1.01 | 16.0 | 19.7 | 140/62 | 15.7 |
| 9 | 9.3 | 25 | 0.015 | 1.24 | 17.3 | 21.3 | 120/81 | 7.1 |
| 9 | 9.3 | 25 | 0.015 | 1.24 | 17.3 | 21.3 | 130/72 | 10.4 |
| 9 | 9.3 | 25 | 0.015 | 1.24 | 17.3 | 21.3 | 140/62 | 14.2 |
| 10 | 10.1 | 25 | 0.015 | 1.31 | 16.9 | 20.3 | 130/74 | 7.0 |
| 10 | 10.1 | 25 | 0.015 | 1.31 | 16.9 | 20.3 | 140/66 | 9.1 |
| 10 | 10.2 | 25 | 0.015 | 1.16 | 17.0 | 20.1 | 120/80 | 5.6 |
| 10 | 10.2 | 25 | 0.015 | 1.16 | 17.0 | 20.1 | 130/73 | 8.5 |
| 10 | 10.2 | 25 | 0.015 | 1.16 | 17.0 | 20.1 | 140/63 | 11.9 |
| 10 | 10.3 | 25 | 0.015 | 1.17 | 17.3 | 20.7 | 120/82 | 5.6 |
| 10 | 10.3 | 25 | 0.015 | 1.17 | 17.3 | 20.7 | 130/72 | 8.7 |
| 10 | 10.3 | 25 | 0.015 | 1.17 | 17.3 | 20.7 | 140/61 | 12.4 |
| 10 | 10.4 | 25 | 0.015 | 1.10 | 16.6 | 19.9 | 121/81 | 5.8 |
| 10 | 10.4 | 25 | 0.015 | 1.10 | 16.6 | 19.9 | 130/70 | 9.0 |
| 10 | 10.4 | 25 | 0.015 | 1.10 | 16.6 | 19.9 | 140/61 | 12.2 |
| 10 | 10.5 | 23 | 0.015 | 1.16 | 16.2 | 19.6 | 120/79 | 7.3 |
| 10 | 10.5 | 23 | 0.015 | 1.16 | 16.2 | 19.6 | 130/71 | 10.7 |
| 10 | 10.5 | 23 | 0.015 | 1.16 | 16.2 | 19.6 | 140/62 | 13.9 |
| 10 | 10.6 | 23 | 0.015 | 1.08 | 15.7 | 18.6 | 120/81 | 4.9 |
| 10 | 10.6 | 23 | 0.015 | 1.08 | 15.7 | 18.6 | 130/71 | 7.9 |
| 10 | 10.6 | 23 | 0.015 | 1.08 | 15.7 | 18.6 | 140/63 | 10.6 |

| | | | | | |
|---|---|---|---|---|---|
| Average | 1.21 | 16.0 | 19.4 | 115/85 | 5.0 |
| Std. Dev. | 0.22 | 0.89 | 1.15 | 120/80 | 6.5 |
| Max | 1.87 | 18.2 | 22.4 | 130/70 | 9.8 |
| Min | 0.92 | 14.1 | 17.2 | 140/60 | 12.4 |
| | | | | Overall | 9.6 |

TABLE 8
Data on graft-deployed aortas.

| | | Compliance with graft | | | | | |
|---|---|---|---|---|---|---|---|
| | | | Average | | | | |
| | | Max and Min | compliance | Avg. OD | | Wireform | |
| | Expansion | pressure for | with graft | (mm) of graft | Equilibrium | recoil @ | |
| | due to | graft-deployed | OD | deployed | OD of | equilibrium | |
| | wireform | aorta testing | amplitude/ID | aorta @ 100 | wireform @ | position (100 | Oversizing |
| Test # | (mm) | (mm Hg) | (percent) | mm Hg | 100 mm Hg | mm Hg) | (mm) |
| 3.2 | 1.88 | 117/88 | 1.1 | 24.1 | 21.5 | 1.5 | 3.7 |
| 3.2 | 1.88 | 121/77 | 1.5 | 24.1 | 21.5 | 1.5 | 3.7 |
| 3.3 | 0.15 | 118/87 | 1.6 | 21.1 | 18.9 | 0.1 | 0.6 |
| 3.3 | 0.15 | 119/80 | 2.3 | 21.1 | 18.9 | 0.1 | 0.6 |
| 3.3 | 0.15 | 128/74 | 3.9 | 21.1 | 18.9 | 0.1 | 0.6 |
| 4.1 | 1.25 | 115/85 | 0.9 | 23.3 | 21.0 | 4.0 | 5.6 |
| 4.1 | 1.25 | 120/79.4 | 1.2 | 23.3 | 21.0 | 4.0 | 5.6 |
| 4.1 | 1.25 | 130/69 | 1.6 | 23.3 | 21.0 | 4.0 | 5.6 |
| 4.2 | 1.62 | 115/85 | 1.0 | 23.4 | 21.2 | 1.8 | 3.7 |
| 4.2 | 1.62 | 120/80 | 1.4 | 23.4 | 21.2 | 1.8 | 3.7 |
| 4.2 | 1.62 | 130/70 | 2.1 | 23.4 | 21.2 | 1.8 | 3.7 |
| 4.3 | 1.58 | 115/85 | 1 | 22.3 | 19.6 | 5.4 | 7.3 |
| 4.3 | 1.58 | 120/80 | 1.3 | 22.3 | 19.6 | 5.4 | 7.3 |
| 4.3 | 1.58 | 130/70 | 1.7 | 22.3 | 19.6 | 5.4 | 7.3 |
| 4.4 | 0.35 | 115/85 | 1.7 | 22.9 | 20.6 | 0.4 | 1.0 |
| 4.4 | 0.35 | 120/80 | 2.4 | 22.9 | 20.6 | 0.4 | 1.0 |
| 4.4 | 0.35 | 130/69 | 4.0 | 22.9 | 20.6 | 0.4 | 1.0 |
| 5.1 | 3.08 | 115/86 | 0.53 | 25.9 | 23.4 | 1.6 | 4.4 |
| 5.1 | 3.08 | 120/81 | 0.78 | 25.9 | 23.4 | 1.6 | 4.4 |
| 5.1 | 3.08 | 130/70 | 1.35 | 25.9 | 23.4 | 1.6 | 4.4 |
| 5.2 | 3.61 | 115/85 | 0.89 | 26.2 | 22.4 | 2.6 | 6.6 |
| 5.2 | 3.61 | 120/81 | 1.19 | 26.2 | 22.4 | 2.6 | 6.6 |
| 5.2 | 3.61 | 130/70 | 1.84 | 26.2 | 22.4 | 2.6 | 6.6 |
| 5.3 | 3.98 | 115/85 | 0.74 | 25.2 | 21.4 | 3.6 | 7.9 |
| 5.3 | 3.98 | 120/80 | 0.96 | 25.2 | 21.4 | 3.6 | 7.9 |
| 5.3 | 3.98 | 130/71 | 1.21 | 25.2 | 21.4 | 3.6 | 7.9 |
| 5.4 | 2.74 | 115/86 | 0.53 | 23.5 | 21.4 | 1.6 | 4.7 |
| 5.4 | 2.74 | 120/79 | 0.79 | 23.5 | 21.4 | 1.6 | 4.7 |
| 5.4 | 2.74 | 130/71 | 1.21 | 23.5 | 21.4 | 1.6 | 4.7 |
| 6.1 | 1.44 | 115/85 | 0.5 | 26.1 | 23.8 | 1.2 | 3.0 |
| 6.1 | 1.44 | 120/81 | 0.58 | 26.1 | 23.8 | 1.2 | 3.0 |
| 6.1 | 1.44 | 130/71 | 0.98 | 26.1 | 23.8 | 1.2 | 3.0 |
| 6.2 | 3.91 | 115/84.3 | 0.46 | 25.3 | 22.7 | 2.3 | 6.6 |
| 6.2 | 3.91 | 121/80 | 0.61 | 25.3 | 22.7 | 2.3 | 6.6 |
| 6.2 | 3.91 | 130/70 | 0.8 | 25.3 | 22.7 | 2.3 | 6.6 |
| 6.3 | 3.14 | 115/84 | 0.44 | 24.1 | 21.8 | 1.2 | 4.8 |
| 6.3 | 3.14 | 120/80 | 0.53 | 24.1 | 21.8 | 1.2 | 4.8 |
| 6.3 | 3.14 | 130/70 | 0.76 | 24.1 | 21.8 | 1.2 | 4.8 |
| 8.1 | 2.77 | 115/85 | 0.60 | 22.0 | 20.0 | 5.0 | 7.8 |
| 8.1 | 2.77 | 120/80 | 0.70 | 22.0 | 20.0 | 5.0 | 7.8 |
| 8.1 | 2.77 | 130/70 | 1.01 | 22.0 | 20.0 | 5.0 | 7.8 |
| 8.2 | 3.16 | 115/86 | 0.57 | 23.0 | 20.6 | 4.4 | 7.9 |
| 8.2 | 3.16 | 120/80 | 0.74 | 23.0 | 20.6 | 4.4 | 7.9 |
| 8.2 | 3.16 | 130/72 | 1.12 | 23.0 | 20.6 | 4.4 | 7.9 |
| 8.3 | 1.52 | 115/85 | 0.50 | 24.1 | 21.8 | 3.2 | 5.1 |
| 8.3 | 1.52 | 120/81 | 0.86 | 24.1 | 21.8 | 3.2 | 5.1 |
| 8.3 | 1.52 | 129/70 | 0.95 | 24.1 | 21.8 | 3.2 | 5.1 |
| 8.4 | 3.21 | 115/85 | 0.53 | 25.0 | 22.6 | 2.4 | 6.0 |
| 8.4 | 3.21 | 120/80 | 0.61 | 25.0 | 22.6 | 2.4 | 6.0 |
| 8.4 | 3.21 | 130/70 | 0.96 | 25.0 | 22.6 | 2.4 | 6.0 |
| 9.1 | 3.56 | 120/81 | 0.31 | 25.0 | 23.2 | 1.8 | 5.7 |
| 9.1 | 3.56 | 130/73 | 0.51 | 25.0 | 23.2 | 1.8 | 5.7 |
| 9.1 | 3.56 | 140/62 | 0.54 | 25.0 | 23.2 | 1.8 | 5.7 |
| 9.2 | 2.29 | 120/81 | 0.47 | 24.0 | 22.0 | 3.0 | 5.7 |
| 9.2 | 2.29 | 130/72 | 0.82 | 24.0 | 22.0 | 3.0 | 5.7 |
| 9.2 | 2.29 | 140/62 | 1.28 | 24.0 | 22.0 | 3.0 | 5.7 |
| 9.3 | 2.53 | 120/81 | 0.47 | 26.3 | 23.8 | 1.2 | 4.1 |
| 9.3 | 2.53 | 130/71 | 0.66 | 26.3 | 23.8 | 1.2 | 4.1 |
| 9.3 | 2.53 | 140/60 | 0.99 | 26.3 | 23.8 | 1.2 | 4.1 |
| 10.1 | 2.78 | 120/79 | 0.52 | 25.7 | 23.1 | 1.9 | 5.0 |
| 10.1 | 2.78 | 131/69 | 0.80 | 25.7 | 23.1 | 1.9 | 4.7 |
| 10.1 | 2.78 | 142/60 | 0.99 | 25.7 | 23.1 | 1.9 | 4.7 |
| 10.2 | 3.04 | 120/80 | 0.64 | 25.5 | 23.2 | 1.8 | 5.3 |
| 10.2 | 3.04 | 130/70 | 0.93 | 25.5 | 23.2 | 1.8 | 5.3 |
| 10.2 | 3.04 | 140/62 | 1.28 | 25.5 | 23.2 | 1.8 | 5.3 |
| 10.3 | 3.09 | 120/80 | 0.49 | 26.1 | 23.8 | 1.2 | 4.7 |
| 10.3 | 3.09 | 130/70 | 0.84 | 26.1 | 23.8 | 1.2 | 4.7 |
| 10.3 | 3.09 | 141/60 | 1.27 | 26.1 | 23.8 | 1.2 | 4.7 |
| 10.4 | 2.95 | 120/81 | 0.59 | 25.1 | 22.9 | 2.1 | 5.5 |
| 10.4 | 2.95 | 130/71 | 0.99 | 25.1 | 22.9 | 2.1 | 5.5 |
| 10.4 | 2.95 | 140/62 | 1.34 | 25.1 | 22.9 | 2.1 | 5.5 |
| 10.5 | 2.13 | 120.7/80 | 0.43 | 24.0 | 21.7 | 1.3 | 3.8 |
| 10.5 | 2.13 | 130/70 | 0.74 | 24.0 | 21.7 | 1.3 | 3.8 |
| 10.5 | 2.13 | 141/60 | 1.15 | 24.0 | 21.7 | 1.3 | 3.8 |
| 10.6 | 2.57 | 120/80 | 0.35 | 23.3 | 21.2 | 1.9 | 4.8 |
| 10.6 | 2.57 | 130/70 | 0.65 | 23.3 | 21.2 | 1.9 | 4.8 |
| 10.6 | 2.57 | 140/60 | 0.84 | 23.3 | 21.2 | 1.9 | 4.8 |

What is claimed is:

1. A stent or stented graft compliance test assembly, comprising:
an animal tissue tube having opposed free ends and defining an inner lumen;
a pre-tester including fixtures adapted to sealingly couple to the free ends of the animal tissue tube and a fluid supply in communication with at least one of the fixtures and the animal tissue tube lumen; and
a stent or stented graft positioned within the animal tissue tube.

2. The assembly of claim 1, wherein the animal tissue is porcine.

3. The assembly of claim 2, wherein the animal tissue tube is a section of porcine aorta with any side branches ligated.

4. The assembly of claim 1, further including a pulsatile pumping system for the fluid supply that pressurizes the animal tissue tube lumen to pressures found in the human vascular system.

5. The assembly of claim 1, further including a sensor for measuring the exterior diameter of the animal tissue tube.

6. The assembly of claim 5, wherein the sensor is a non-contact sensor.

7. The assembly of claim 6, wherein the sensor is a laser micrometer.

8. The assembly of claim 5, wherein the assembly includes a stented graft having multiple individual wires at axially spaced locations along an outer graft tube, and wherein the sensor is positioned to measure the exterior diameter of the animal tissue tube at the axially spaced locations.

9. A method of testing the compliance of a stent or stented graft, comprising:
sealingly coupling opposed free ends of an animal tissue tube onto fixtures of a pre-tester, the animal tissue tube having a lumen;
positioning a stent or stented graft within the animal tissue tube; and
providing a fluid to the animal tissue tube lumen via at least one of the fixtures.

10. The method of claim 9, further including pressurizing the fluid in the animal tissue tube lumen to pulsatile pressures found in the human vascular system.

11. The method of claim 10, further including measuring the exterior diameter of the animal tissue tube at different pressures.

12. The method of claim 11, further including:
recording the data on the measured exterior diameter of the animal tissue tube;
sealingly coupling opposed free ends of a synthetic tube onto fixtures of a tester, the synthetic tube having a lumen;
positioning within the synthetic tube a stent or stented graft of the same kind as was pre-tested in the animal tissue tube;
providing a fluid to the synthetic tube lumen via at least one of the fixtures of the tester;
pressurizing the fluid in the synthetic tube lumen at a pulsed rate; and
measuring the exterior diameter of the synthetic tube and controlling the fluid pressure based on the recorded data.

13. The method of claim 12, wherein the fluid pressure within the synthetic tube lumen is controlled to expand the diameter of the synthetic tube to the same dimension as the measured diameter of the exterior diameter of the animal tissue tube.

14. The method of claim 13, wherein the animal tissue tube lumen is pressurized to both normal and abnormal pulsatile pressures found in the human vascular system, and the synthetic tube lumen is pressurized at a pulsed rate based on the measured exterior diameter of the animal tissue tube to simulate both normal and abnormal compliance conditions.

15. The method of claim 9, wherein the step of positioning comprises positioning in the animal tissue tube a stented graft having multiple individual wires at axially spaced locations along an outer graft tube, and further including:
pressurizing the fluid in the animal tissue tube lumen to pulsatile pressures found in the human vascular system; and
measuring the exterior diameter of the animal tissue tube at the axially spaced locations and at different pressures.

16. The method of claim 15, further including:
recording the data on the measured exterior diameter of the animal tissue tube;
sealingly coupling opposed free ends of a synthetic tube onto fixtures of a tester, the synthetic tube having a lumen;
positioning within the synthetic tube a stented graft of the same kind as was pre-tested in the animal tissue tube;
providing a fluid to the synthetic tube lumen via at least one of the fixtures of the tester;
pressurizing the fluid in the synthetic tube lumen at a pulsed rate; and
measuring the exterior diameter of the synthetic tube at the axially spaced locations while controlling the fluid pressure based on the recorded data such that the diameters of the synthetic tube at the axially spaced locations expands to the same dimensions as the measured diameter of the exterior diameter of the animal tissue tube at the axially spaced locations.

17. A method of testing the compliance of a stent or stented graft, comprising:
sealingly coupling opposed free ends of a pre-tester tube onto fixtures of a pre-tester, the pre-tester tube having a lumen;
positioning a stent or stented graft within the pre-tester tube;
providing a fluid to the pre-tester tube lumen via at least one of the fixtures;
pressurizing the fluid in the pre-tester tube lumen to pulsatile pressures found in the human vascular system;
measuring the exterior diameter of the pre-tester tube at different pressures;
recording the data on the measured exterior diameter of the pre-tester tube;
sealingly coupling opposed free ends of a tester tube onto fixtures of a tester, the tester tube having a lumen;
positioning within the tester tube a stent or stented graft of the same kind as was pre-tested in the pre-tester tube;
providing a fluid to the tester tube lumen via at least one of the fixtures of the tester;
pressurizing the fluid in the tester tube lumen at a pulsed rate; and
measuring the exterior diameter of the tester tube while controlling the fluid pressure based on the recorded data.

18. The method of claim 17, wherein the fluid pressure within the tester tube lumen is controlled to expand the diameter of the tester tube to the same dimension as the measured diameter of the exterior diameter of the pre-tester tube.

19. The method of claim 18, wherein the pre-tester tube lumen is pressurized to both normal and abnormal pulsatile pressures found in the human vascular system, and the tester tube lumen is pressurized at a pulsed rate based on the measured exterior diameter of the pre-tester tube to simulate both normal and abnormal compliance conditions.

20. The method of claim 17, wherein the pre-tester tube is made of animal tissue.
